(19) United States
(12) Patent Application Publication
(10) Pub. No.: US 2020/0071887 A1
(43) Pub. Date: Mar. 5, 2020

(54) Tufted Geotextile With Increased Shear Resistance To Hydraulic Infill Displacement And Dry-Flow Loading

(71) Applicant: Watershed Geosynthetics LLC, Alpharetta, GA (US)

(72) Inventors: William Delaney Lewis, West Monroe, LA (US); Kyle Ehman, Milton, GA (US); Jose L. Urrutia, Suwanee, GA (US)

(73) Assignee: Watershed Geosynthetics LLC, Alpharetta, GA (US)

(21) Appl. No.: 16/558,235

(22) Filed: Sep. 2, 2019

Related U.S. Application Data
(60) Provisional application No. 62/726,138, filed on Aug. 31, 2018.
(60) Provisional application No. 62/742,588, filed on Oct. 8, 2018.

(51) Int. Cl. E01C 13/08; B09B 1/00

(52) U.S. Cl. CPC E01C 13/08; B09B 1/004

(57) ABSTRACT

A tufted geotextile for covering a land surface, comprising a porous backing sheet densely tufted to provide simulated grass blades having interstices therebetween on a tuft gauge of about 20 tufts per foot to about 50 tufts per foot and the adjacent lines spaced about ¼ inch, the interstices for receiving an infill from the backing sheet to a fill plane to increase shading of the interstices by the tuft blades on the backing sheet while resisting hydraulic displacement and movement of the infill while overlying the ground surface for covering purposes. A closure system is disclosed using the tufted geotextile as a component overlying an impermeable geomembrane for resisting inflow of water below the ground surface.

This application claims benefit of U.S. Provisional Patent Application Ser. No. 62/726,138 filed Aug. 31, 2018 and benefit of U.S. Provisional Patent Application Ser. No. 62/742,588 filed Oct. 8, 2018.

### TECHNICAL FIELD

The present invention relates to geotextile sheets for land site covers and closure systems. More particularly, the present invention relates to tufted geotextile sheets having shear resistance against hydraulic infill displacement with porous backings densely tufted to cooperatively stabilize the infill from displacement and against dry-flow and thermal displacements of the geotextile and the infill.

In this application, the following terms will be understood to have the indicated definitions:

waste sites—refers to earthen berms and to sites where waste is deposited, such as landfills, phosphogypsum stacks, environmentally impacted land, leach pads, mining spoils and environmental closures or material stockpiles that require a closure or cover system;

synthetic grass—refers to a composite of at least one geotextile (woven or nonwoven) tufted or knitted with one or more synthetic yarns or strands that has the appearance of grass;

geomembrane—refers to a conventional structured or textured polymeric material, such as high density polyethylene, very low density polyethylene, linear low density polyethylene, polyvinyl chloride, etc, provided as an impermeable sheet for liner purposes in the waste site and land site industry.

### BACKGROUND OF THE INVENTION

Large area land sites occupied for use as waste sites, landfills, stockpiles, and power plant disposal fields remain open typically for a number of years for receiving waste materials, mining spoils or power plant wastes and ash, landfill trash and municipal solids and liquids wastes. Waste sites typically have steep slopes rising from a toe or base to an upper elevated apex or peak. The elevation over time with deposits of fill materials may typically reach several hundred feet above the toe. While steep slopes allow increased storage volume, steep slopes experience significantly high shear forces. These forces occur in response to the fill materials loaded in within a vertical portion of the area allocated for the landfill and also arise from precipitation and water flow such as from rain fall on the waste site that generates high volumes of water flowing downwardly to the toe. Steep slopes often experience large and rapid run-off. Upon reaching an appropriate capacity for the particular site, the site is closed to receiving additional waste materials. In the interim, however, filled portions of large area land sites may gainfully use a covering to reduce or, with an impermeable component in a covering system to block, water inflow into the land site and to reduce disturbances of the in-fill materials pending closure. Some such temporary coverings may require ten or more years expected longevity. Such covering may also be gainfully applied for long term final covering systems.

The structure of landfills and waste sites are subject to environmental regulations for construction, operation, and closing after design capacity is reached. Construction regulations routinely require lining of a base of landfill with an impermeable geomembrane liner. The liner restricts flow of water and contaminates from the fill material and precipitation into ground water below the landfill. Rather, water is channeled to a treatment facility prior to discharge. The geomembrane however may slip or move in response to shear forces, and slippage may cause damage to the geomembrane as well as site failure and avalanche-type sliding collapse of the fill material. Such failure and damage incurs significant cost to remedy particular if the failure causes openings in the liner which then must be replaced in order to maintain impermeability.

Land site filling operations typically involve depositing waste materials in specific laydown areas. The deposited waste materials are often covered with a soil layer to form a cell. Adjacent cells are formed with subsequently deposited waste materials. Closure of the site upon reaching design capacity involves overlaying a covering of sealing materials on exposed surfaces of the landfill. Notwithstanding closure, the land sites have ongoing costs including monitoring for leaching of wastes and contaminates into water systems and streams, collection and discharge of gases from the waste site, and periodic maintenance to maintain the closure covering. Previous efforts to close such sites involved overlaying the site with an earthen soil layer. High water flow however, erodes soil covering, and vegetation providing resistance to erosion, requires cutting and growth control. Further, high water flow may require installation of benches around the perimeter of the side spaced, for example, typically at 100 feet to 150 feet intervals, to minimize soil erosion. The benches are substantially leveled broad interruptions or steps in the slope and extend along a contour. The bench typically includes a guttering system, or down chutes, for receiving water flow from the slope and channel the water to a catch basin for storage, treatment if any, and discharge to a water system or waterway. The bench may also provide a roadway for vehicles to move along the sloped ground.

In recent years, large area sites are closed with covering formed with elongated sheets of an impermeable geomembrane. The geomembrane seals the site from inflow of wind and water such as from rain and snow, and thereby prevents wastes and contaminates from infiltration into streams and ground water. The membranes often must be secured with anchors and trench systems to resist wind uplift. However, it is disfavored to use anchors that pierce the geomembrane to prevent openings that may allow water flow into the underlying fill materials in the waste site.

To provide aesthetics and water flow control, tufted geotextiles have been overlaid on exposed membranes. Our prior U.S. Pat. No. 8,403,597 discloses a cover system for waste sites effective in resisting wind uplift and remaining in-place with frictional contact between the geomembrane and the geotextile. The tufted geotextile provides a field of synthetic grasses with short blades extending from the geotextile backing sheet. In such installations, granular material infill may fill interstices of the tufts. The granular material assists with loading to resist wind uplift, filters water flowing through the geotextile into a synthetic drainage on the geomembrane, and assisting with reducing exposure of the geotextile to UV and deterioration.

While meeting closure system needs in the industry, there are opportunities for reduced costs in materials and maintenance while increasing longevity of the installed cover. The water flow creates hydraulic shear loading and may cause the granular infill material to be displaced and move, and thus require periodic maintenance to replace infill in areas that the infill has thinned. There are alternatives that reduce infill movement (i.e., increase infill shear resistance). While these have benefits as to maintenance for installed systems, increased tuft gauge and reduced tuft blade lengths have the countering drawbacks of reduced friction resistance of the tufted geotextile and geomembrane that restricts applications to less steeply sloped installations.

Further, the changes increase UV exposure and lead to degradation of the backing sheet of the tufted geotextile covering, and thus reduce the operational life for a tufted geotextile cover or a closure system for waste sites.

The need for benches also incurs installation and maintenance costs. The cover systems also typically involve the use of motor vehicles over the installed cover system for inspection and maintenance purposes. The overlaid tufted geotextile/geomembrane system thus preferably accommodates use of motor vehicles while resisting cutting and trenching and damaging the frictional interface that retains the geotextile overlaid on slopes of the covered landfill.

Accordingly, there is a need in the art for a geotextile having increased shear resistance against hydraulic infill displacement with tufting density to cooperatively stabilize the infill from displacement. It is to such that the present invention is directed.

### SUMMARY OF THE INVENTION

The present invention meets the need in the art by providing an improved tufted geotextile for use with covering and closing waste sites and land surfaces. The tufted geotextile comprises at least one backing sheet densely tufted with yarns that extend from the backing sheet as simulated grass blades having interstices therebetween and formed in spaced-apart lines of tufts on a spacing gauge and spacing of adjacent rows to densely increase shading of the interstices by the tuft blades on the backing sheet with infill received in the interstices, said spacing gauge in a range of about 20 tufts per foot to about 50 tufts per foot and lines spaced about ¼ inch apart, said backing sheet porous for permitting water flow therethrough, to resist hydraulic and dry-flow displacement and movement of the infill received in the interstices between adjacent tufts. The tufted geotextile readily overlies a ground surface for covering purposes as well as installs as a component in a closure system that uses a geomembrane for shear resistance and impermeability for a land site such as a landfill, roadway foundation, backfill support for retaining walls, and other soil/waste site applications.

The tufted geotextile as recited above, in which the backing sheet has a basis weight of about 2 ounces per square yard to about 40 ounces per square yard.

The tufted geotextile as recited above, in which the backing sheet has basis weight of about 3 ounces per square yard.

The tufted geotextile recited above, in which the backing sheet comprises a first backing sheet and a second backing sheet tufted together with polymeric yarns for defining the tufts extending from a surface of the first backing sheet. The tufted geotextile recited above, wherein the first backing sheet and the second backing sheet each have a basis weight totaling about 2 ounces per square yard to about 40 ounces per square yard.

The tufted geotextile recited above, wherein the first backing sheet and the second backing sheet each have a basis weight of about 20 ounces per square yard to about 60 ounces per square yard.

The tufted geotextile recited above, in which the backing sheet comprises one or more backing sheets tufted together with polymeric yarns for defining the tufts extending from a surface of a first one of the backing sheets.

The tufted geotextile recited above, wherein the polymeric yarns include UV resistant additives.

The tufted geotextile recited above, wherein the yarns for the backing sheet includes UV resistant additives.

The tufted geotextile recited above, wherein the polymeric yarns for the backing sheet include fire resistant additives.

The tufted geotextile recited above, wherein the polymeric yarns for the tufts include fire resistant additives.

The tufted geotextile recited above, wherein the tufts in the adjacent rows have blades of a first length in a first row and of a second length in an adjacent row, in which the first length is greater than the second length, which system provides for increased density yet reduces materials costs.

In another aspect, the present invention meets the need in the land site coverage art by providing a cover system with high shear resistance, comprising a geomembrane and a synthetic grass composite comprising a geotextile having a plurality of spaced-apart tufts tufted with one or more synthetic yarns to form a plurality of elongated blades extending therefrom, the tufts defining interstices therebetween from the geotextile to a fill plane defined by about a distal extent of the blades. The interstices receive an infill, whereby the extending blades cooperatively with the infill shadow the interstices from the surface of the backing sheet of the geotextile to proximate the fill plane from UV exposure and resisting infill displacement in response to hydraulic shear loading.

The cover system recited above, wherein the first geotextile has a basis weight of at least about 2 ounces per square yard.

The cover system recited above, further comprising a second geotextile tufted to the first geotextile.

The cover system recited above, wherein the first geotextile and the second geotextile each have a respective basis weight totaling about at least 2 ounces per square yard.

The cover system recited above, wherein the first geotextile and the second geotextile each have a basis weight of about at least 4 ounces per square yard.

The cover system recited above, wherein the tufts are tufted in a line with a tuft gauge of about 20 to about 50 tufts per foot machine direction.

The cover system recited above, wherein the tufts are tufted in a line with a tuft gauge of about 27 tufts per foot machine direction.

The cover system recited above, where adjacent tuft lines are spaced on about a ¼ inch gauge.

The cover system recited above, in which the tufts in the adjacent rows of the tufted geotextile have blades of a first length in a first row and of a second length in an adjacent row, in which the first length is greater than the second length, which system provides for increased density yet reduces materials costs.

The cover system recited above, wherein the geotextile has a tensile strength of about 1,000 pounds per foot to about 4,000 pounds per foot.

The cover system recited above, wherein the geomembrane provides a frictional interface resistant to shear forces or a mechanical interface, and the geomembrane may have opposing smooth surfaces, textured surfaces, and/or extending projections.

The cover system recited above, wherein the polymeric yarns for the tufts include UV resistant additives.

The tufted geotextile recited above, wherein the yarns for the backing sheet includes UV resistant additives.

The cover system recited above, wherein the yarns for the backing sheet of the geotextile have a fire retardant additive.

The tufted geotextile recited above, wherein the polymeric yarns for the tufts include fire resistant additives.

### BRIEF DESCRIPTION OF THE DRAWINGS

FIG. 1 illustrates in perspective view a tufted geotextile in accordance with the present invention.

FIG. 2 illustrates in perspective exploded view a geotextile having a first and a second backing sheet tufted in accordance with the present invention.

FIG. 3 illustrates in exploded cross-sectional view the geotextile deployed as a covering over a land site in accordance with the present invention.

FIG. 4 illustrates in schematic cross-sectional view the geotextile in accordance with the present invention installed as a component of a closure system on a steep slope land site.

FIG. 5 illustrates in perspective view an alternate embodiment of a tufted geotextile in accordance with the present invention.

FIG. 6 illustrates in end elevational view the alternate embodiment of the tufted geotextile shown in FIG. 5

### DETAILED DISCUSSION

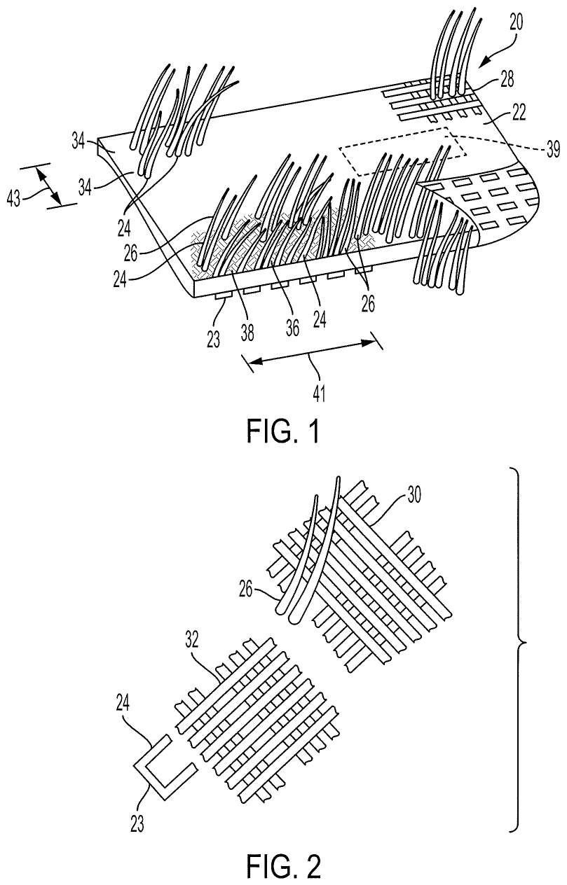

With reference to the drawings, in which like parts have like identifiers, FIG. 1 illustrates in perspective view a tufted geotextile 20 in accordance with the present invention. The tufted geotextile 20 comprises a backing sheet 22 tufted with polymeric yarns that when tufted form bridges 23 on a back side of the backing sheet to form a plurality of tufts 24 that extend as grass-like blades 26 (for example, elongated thin narrow ribbon-like elements) from an upper surface of the backing sheet. In the illustrated embodiment, the backing sheet 22 is woven as shown generally at 28 in detailed view with warp and waft yarns, although a nonwoven sheet may be used. The backing sheet 22 has a weight basis or mass of between about 2 ounces per square yard to about 40 ounces per square yard.

The tufted geotextile 20 may comprise one or more backing sheets. In the embodiment illustrated in FIG. 2, the backing sheet 22 comprises a first backing sheet 30 and a second backing sheet 32. The tufting yarns interweave through the backing sheets 30, 32 to secure the backing sheets closely together with the spaced-apart rows 34 of yarns that extend through the geotextile sheet 20 as the grass-like blades 26. The blades 26 extend from the backing sheet 22 about ½ inch to about 4 inches, and more preferably from about 1 inch to about 1½ inches. The adjacent blades 26 define interstices 36 between the tufts 24. The interstices 36 receive a granular infill 38 selectively to a fill plane 39 (a greatest extent defined by about a distal extent of the blades 26).

The backing sheet 22 (or 30, 32) form of a polymer material that resists exposure to sunlight that generates heat rise in the geotextile 20 and that resists ultraviolet (UV) radiation in the sunlight, which degrades the backing sheet and the tufted blades. The polymer yarns further should not become brittle when subjected to low temperatures. The color selection of the yarns for the backing sheet 22 are preferably black and/or gray yarns. The color selection for the tufting yarns are green or brown, to simulate grasses. The tufts may be tufted in combinations for closer simulation of the area to be covered, for example using a respective proportion of a first, second, or more, color yarns. Further, the polymeric material for the yarns that are woven to form the backing sheet or the polymers spun bond for a non-woven backing sheet, include UV resistant additives such as HALS and carbon black. The polymers are selected to provide high shear strength resistance for the geotextile 20. The backing sheet has strong tensile strength, in a range of about 800 pounds per foot to about 4,000 pounds per foot.

### Tufted Geotextile

With continuing reference to FIG. 1, the tufted geotextile 20 includes a dense tufting of closely spaced tufts 24. In the illustrated embodiment, the yarns tuft along spaced-apart machine direction lines with a tuft gauge 41 of about 27 tufts per foot machine direction. The adjacent tuft lines 34 are spaced 43 on about a ¼ inch center. The cover geotextile 20 in the illustrated embodiment employs about 1,256 tufts per square foot, which tufting density reduces the gap spacing between the blades 26, facilitates shadowing by the blades on the backing sheet 22 and portions of adjacent blades, and reduces UV exposure of the backing sheet, which leads to geotextile degradation and damage to the cover. The dense tufting in accordance with the present invention reflects an approximate 30% increase in tuft density over tufted geotextiles used previously with land site covering applications. Accordingly, the tufting gauge may range from about 20 tufts per foot to about 50 tufts per foot, with yarn having a diameter in a range of about 40 micron to about 400 micron, more preferably about 80 micron to about 300 micron, and more preferably about 140 micron, balancing yarn size with density for achieving shadowing increase. The increase in tuft density arises from changes in tuft gauge 41 (machine direction) and tuft row spacing 43 (cross-direction), with the beneficial effect of increased shadowing by the blades 26 of the geotextile sheet 22 and reduced interstitial spaces 36 between the blades 26 of the adjacent tufts 24 which cooperatively resists displacement of infill 38 received in the tufted geotextile 20 due to hydraulic shear forces or dry-flow loading (from wind, vibrations, or thermal expansion and contraction, for example).

The grass-like component forming the blades 26 preferably consists of polyethylene fibers that when tufted, extend upwardly about 0.5 inches to about 4.0 inches from the backing sheet 22, more preferably about 1.0 inches to about 2.5 inches in length, tufted into the backing sheet. The embodiment illustrated in FIG. 2 having the first and second backing sheets 30, 32 tufted together provides increased slippage resistance of increased friction, for example, resistance strength for use in severely steep side slopes, and provides as the first backing sheet 30 a waste layer for initial UV exposure and degradation during the operational life of the geotextile 20 while protecting the lower second backing sheet 32. The two, or more, layers of backing sheets 30, 32 tufted together affords improved dimensional stability having an increased lifetime duration.

The geotextile has a tensile strength of about 800 pounds per foot to about 4,000 pounds per foot.

The grass filaments formed by the tufted yarns preferably have an extended operational life of at least about 50 years to about 100 years. The yarns for the tufts of synthetic grass blades are preferably polyethylene or polypropylene, or other polymeric.

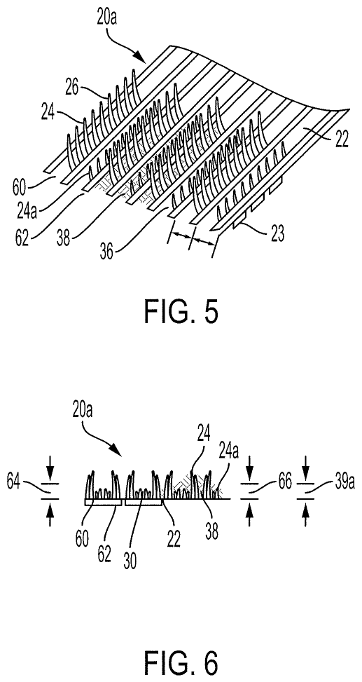

FIG. 5 illustrates in perspective view an alternate embodiment of a tufted geotextile 20a in accordance with the present invention. FIG. 6 illustrates the tufted geotextile 20a in end elevational view. The tufted geotextile 20a comprises the backing sheet 22 tufted with polymeric yarns in spaced-apart first rows 60 and alternate second rows 62. The tufts 24 in the first rows 60 have a first length 64 extending from the backing sheet 22 to a free distal extent. The tufts 24a in the second rows 60 have a second length 66 extending from the backing sheet 22 to a free distal extent. The first length 64 of the tuft 24 is longer than the second length 66 of the tuft 24a. The adjacent blades 26 of the tufts 24, 24a define the interstices 36 that receive the granular infill 38 selectively to a fill plane 39a which in the alternate embodiment is preferably about the length 66 of the tufts 24a.

In an illustrative embodiment, the alternating rows 60, 62 are spaced on a ¼ inch gauge, and the tufts 24 in the first rows 60 have a pile height or blade length of 1.4 inches while the second rows 62 have a pile height or blade length of 0.5 inches, formed with bridges 23 having a length of 0.41 inches. The alternate embodiment 20a provides infill displacement resistance to hydraulic shear forces while reducing the material requirement for the tufts. In the illustrative embodiment, the tufts 24a in the second row 62 have 43% less material than in the tufts 24 in the first row 60, which provides a 21.5% material reduction for the alternate embodiment 20a compared with the embodiment 20 in which the tufts 24 have the same length 64. The shorter tufts 24a interspersed with the tufts 24 cooperatively define the interstices 36 for the infill 38. The individual blades 26 of the tufts 24, 24a resist the displacement of the infill 38 while the extending blades of the tufts 24 shade the tufted geotextile 20a.

### Infill

The tufted geotextile 20 provides a cover system for overlying a land surface. In an alternate embodiment, the cover system may gainfully use the granular infill 38 received within the backing sheets 22 (30, 32) and the interstices 36 between the tufts 24. The infill 38 is a granular material cooperating with the extending blades 26 of the tufts 24 to shadow the backing sheet 22. The infill 38 fills onto the backing sheet 22 and within the interstices 36 therefrom to about a second extent that is generally less than the fill plane 39 of the geotextile. The infill 38 cooperates with the blades 36 to shadow the backing sheet 22 from UV exposure and degradation.

The infill 38 may be a sand material, and further particularly may comprise a fire retardant additive or product independent of a sand carrier mixture, such as a non-halogenated magnesium hydroxide powder, silicates including potassium silicate, calcium silicate, and sodium silicate, or other in situ fire suppression or resistant material.

The dense tufting of the geotextile 20 in accordance with the invention provides high shear resistance to displacement or movement of the infill 38 arising from hydraulic shear forces of water flow across the geotextile such as caused by rain storms over the covered land site. Rather, the water flow is disrupted and slowed by the extended blades 36, and the water passes through the infill 39, and through the porous backing sheet 22. The water may then enter into the soil below the geotextile 20, or when used in a covering system for closure purposes of a land site, flow over a geomembrane disposed below the geotextile to a collection channel downslope. Further, the dense tufting of the geotextile resists dry flow forces that can result in movement of the geotextile (wrinkles) or of the infill (displacement), caused by wind infiltration, subsurface ground vibrations, site contents settlement and vibrations, or thermal expansions and contractions.

### Cover System For Landfill and Waste Site Closure

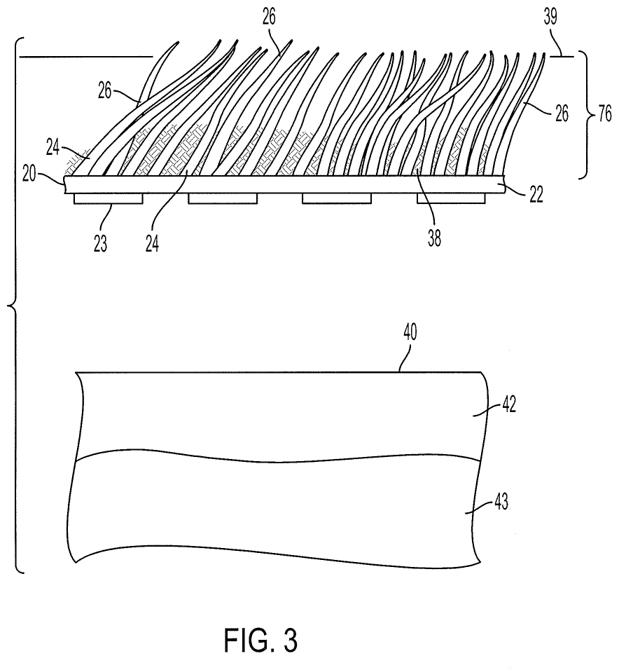

With reference to FIG. 3, the geotextile 20 readily installs over a ground surface 40 with the bottom in contact with the ground surface. The illustrated land site 40 includes a soil overlayment layer 42 that covers waste materials 43 such as in a landfill. The infill 38 provides additional mass for resisting wind uplift of the geotextile 20. The densely tufted geotextile 20 resists displacement of the infill 38 arising from hydraulic shear forces of water flow over the steep slopes (such as in a landfill), such that the granular loose infill 38 remains as placed in the interstices 36 even without a securing material such as cementitious granules that cure in place. The water flows over and around the blades 26 which disrupt flows, and the water passes through the infill 38 and the backing sheet 22 into the soil underneath. Further, the dense tufting of the geotextile resists dry flow forces that can result in movement of the geotextile (wrinkles) or of the infill (displacement), caused by wind infiltration, subsurface ground vibrations, site contents settlement and vibrations, or thermal expansions and contractions.

### Geotextile and Geomembrane Closure System

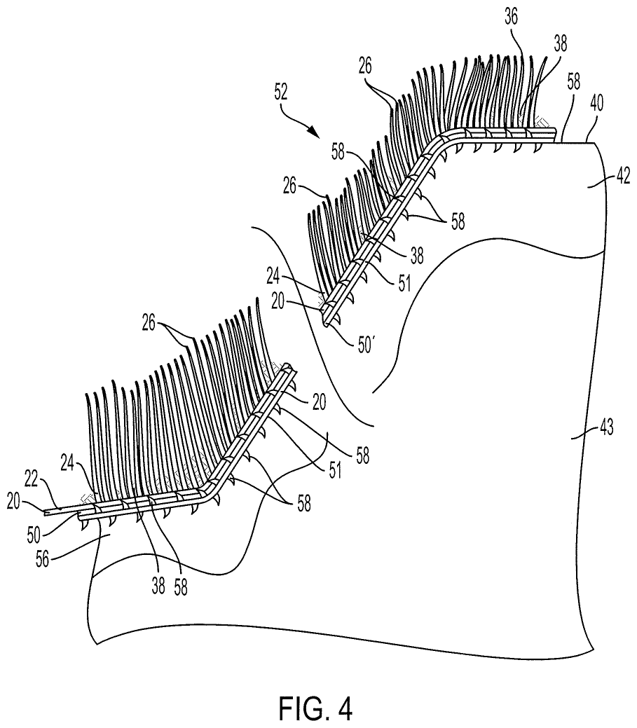

With reference to FIG. 4, the geotextile 20 readily installs alternatively with a geomembrane 50 for a closure covering system 52 for landfills and waste sites. These sites typically have steep slopes from a toe 56 to an apex 58, and may have slopes of up to about 45 degrees with elevational differences of 200 feet or more. The geotextile 20 of the present invention readily installs for site covering or closure purposes without benches intermediate the toe 56 and apex 58, although benches may be employed.

The geomembrane 50 positions with a first surface overlying a land surface. The tufted geotextile 20 then overlies the geomembrane. The geomembrane 50 provides a frictional interface or a mechanical interface resistant to shear forces. The geomembrane 50 may have opposing smooth surfaces, textured surfaces 51, and/or extending projections 58, such as structural drainage features.

As noted above, the geomembrane in one embodiment may include a plurality of projections 58 that extend from one or both opposing surfaces. In this embodiment, the projections pierce into, and mechanically engage with, the back surface of the backing sheet 22. This structure thus provides the cover system 52 having increased shear resistance to displacement of the tufted geotextile 20 relative to the geomembrane 50.

Further, in applications using infill 38, the increased resistance to shear forces resists hydraulic displacement or dry flow movement of the infill 38 in waste site land site covering applications particularly on steeply sloped sites. The penetration of the projections 58 into the geotextile 20 form the mechanical connection between the geomembrane 50 and the geotextile 20. The interface resistance to slippage is based upon the material strength of the geotextile and the projections in combination. The present invention provides high shear strength for a geotextile in a variety of applications including soil coverage and as a component of a closure system having the geomembrane and the geotextile to the resist slippage of the tufted geotextile relative to the geomembrane in response to hydraulic shear loading on the cover system. The dense tufting of the geotextile further resists dry flow forces that can result in movement of the geotextile (wrinkles) or displacement of the infill.

The extending blades 26 shadow the interstices 36 of the geotextile 20 from the surface of the backing sheet 22 to a selected fill level, and may reach about the fill plane 39, and thus reduce exposure of the backing sheet 22 to UV and heat degradation.

The high density of the tufts 24 increases the shear resistance of the geotextile 20 to hydraulic displacement and movement caused by high water flow rates and volumes of water flow across the tufted geotextile. In covering applications that use infill 38, the geotextile 20 resists hydraulic displacement and movement of the infill as water flows across the geotextile, through the infill and through the backing sheet 22 into the soil below with reduced displacement, movement and loss of the infill 38 from the interstices 36.

The foregoing discloses an improved geotextile having increased resistance to hydraulic shear forces on the infill with decreased displacement and movement of the infill (either lost by carry away in flowing waters or creating thin or bare portions and over-fill portions of the cover system requiring periodic maintenance) without the use of securing additives such as cement. The heavy high strength geotextile backing sheets are preferably made with a UV resistant polymer and the dense tufting affords increased shading and cooperatively with the resultant reduced or non-moving infill protects the geotextile from UV degradation for cover system longevity and utility over longer multiple-year weathering periods experienced in covering and closing land site.

In the closure application, the geotextile secures in a first embodiment with the frictional interface to the geomembrane or secures in a second embodiment with the mechanical engagement.

The extending blades of the tufts in cooperation with the infill shadow the geotextile from UV exposure in the interstices from the geotextile to the fill depth while resisting displacement of infill in response to hydraulic shear loading on the cover system.

The alternate embodiment of the tufted geotextile 20a illustrated in FIGS. 5 and 6 provides the improved hydraulic shear and/or dry flow resistance to infill displacement with reduced material requirements.

The fire additive provides a land surface covering resistant to fire.

The features disclosed for the improved geotextile lead to increased usage longevity in land site covering and closure system applications with increased shear resistance to displacement of infill while providing water flow control, and resistance to UV and heat degradation (including in alternate embodiment a waste sheet for initial term degradation protecting a second backing sheet), and fire resistance, for long term covering and closure of land sites.

What is claimed is:

1. A tufted geotextile for use with covering and closing waste sites land land surfaces, comprising at least one backing sheet densely tufted with yarns that extend from the backing sheet as simulated grass blades having interstices therebetween and formed in spaced-apart lines of tufts on a spacing gauge and spacing of adjacent rows to densely increase shading of the interstices by the tuft blades on the backing sheet with infill received in the interstices, said spacing gauge in a range of about 20 tufts per foot to about 50 tufts per foot and said lines spaced about ¼ inch, said backing sheet porous for permitting water flow therethrough, for resisting hydraulic and dry-flow displacement and movement of an infill received in the interstices between adjacent tufts, whereby the tufted geotextile readily overlies a ground surface for covering purposes as well as installs as a component in a closure system that uses a geomembrane for shear resistance for the ground surface for covering purposes.

2. The tufted geotextile as recited in claim 1, wherein the backing sheet has a basis weight of about 2 ounces per square yard to about 20 ounces per square yard.

3. The tufted geotextile recited in claim 1, in which the backing sheet comprises a first backing sheet and a second backing sheet tufted together with the polymeric yarns for defining the tufts extending from a surface of the first backing sheet.

4. The tufted geotextile recited in claim 3, wherein the first backing sheet and the second backing sheet each have a basis weight of about 2 ounces per square yard to about 30 ounces per square yard.

5. The tufted geotextile recited in claim 3, wherein the first backing sheet and the second backing sheet each have a basis weight of about 2 ounces per square yard to about 20 ounces per square yard.

6. The tufted geotextile recited in claim 1, wherein the polymeric yarns include UV resistant additives.

7. The tufted geotextile recited in claim 1, wherein the backing sheet comprises polymeric yarns that include fire resistant additives.

8. The tufted geotextile recited in claim 1, wherein the tufts in the adjacent rows have blades of a first length in a first row and of a second length in an adjacent row, in which the first length is greater than the second length.

9. A cover system for a land site, comprising:
an impermeable geomembrane for overlying a ground surface for restricting water passing therethrough into a subsurface thereunder;
a synthetic grass composite comprising a geotextile having a plurality of spaced-apart tufts tufted with one or more synthetic yarns to form a plurality of elongated blades extending therefrom, the tufts defining interstices therebetween from the geotextile to a fill plane defined by about a distal extent of the blades for receiving an infill, said tufts tufted on a spacing gauge and spacing of adjacent rows to densely increase shading of the interstices by the tuft blades on the backing sheet with infill for being received in the interstices to about the fill plane, said spacing gauge in a range of about 20 tufts per foot to about 50 tufts per foot and said lines spaced about ¼ inch, said backing sheet porous for permitting water flow therethrough, for resisting hydraulic displacement and movement of the infill received in the interstices between adjacent tufts, whereby the tufted geotextile readily overlies the geomembrane on the ground surface for for shear resistance for the ground surface for covering purposes.

10. The cover system as recited in claim 9, wherein the infill comprises a plurality of particles for being received in the interstices, whereby the extending blades cooperatively with the infill shadow the interstices from the geotextile to proximate the fill plane from UV exposure and resisting infill displacement in response to hydraulic shear loading and dry-flow conditions.

11. The cover system as recited in claim 9, wherein the geotextile has a basis weight of at least about 2 ounces per square yard.

12. The cover system as recited in claim 9, further comprising a second geotextile tufted to the first geotextile as a composite assembly.

13. The cover system as recited in claim 12, wherein the first geotextile and the second geotextile each have a respective basis weight totaling about at least 20 ounces per square yard.

14. The cover system as recited in claim 9, wherein the first geotextile and the second geotextile each have a basis weight of about at least 2 ounces per square yard.

15. The cover system as recited in claim 9, wherein the tufts are tufted with a tuft gauge of about 27 tufts per foot machine direction.

16. The cover system as recited in claim 9, where adjacent tuft lines are spaced on about a ¼ inch center.

17. The cover system as recited in claim 9, wherein the tufts in the adjacent rows of the tufted geotextile have blades of a first length in a first row and of a second length in an adjacent row, in which the first length is greater than the second length.

18. The cover system as recited in claim 9, wherein the backing sheet comprises polymeric yarns that include UV resistant additives.

19. The cover system as recited in claim 9, wherein the geotextile has a fire retardant additive.
